(19) United States
(12) Patent Application Publication
(10) Pub. No.: US 2016/0356640 A1
(43) Pub. Date: Dec. 8, 2016

(54) Receptacle Scale for Measuring a Weight of a Receptacle

(71) Applicant: Joseph M. Freeman, Omaha, NE (US)

(72) Inventor: Joseph M. Freeman, Omaha, NE (US)

(21) Appl. No.: 14/731,630

(22) Filed: Jun. 5, 2015

(51) Int. Cl. G01G 19/52; B65F 1/14; G08B 21/18; G01G 23/18

(52) U.S. Cl. CPC G01G 19/52; G01G 23/18; B65F 1/1484; B65F 1/141; G08B 21/182; B65F 2210/184

(57) ABSTRACT

A receptacle scale comprises a fitted base, a connected indicator, and an integrated scale. The receptacle scale weighs trash, receptacles, inventory or other objects. The bottom of a receptacle rests upon the fitted base of the receptacle scale. Additionally, the fitted base may attach to a mobile dolly for moving the receptacle. The receptacle scale is a standalone apparatus that may act as an accessory with already existing designs for receptacles and dollies.

### BACKGROUND OF THE INVENTION

Waste receptacles, transport containers, drums, and the like are commonplace in a variety of environments. These receptacles are regularly lifted, moved, and/or emptied, among other things. For example, homeowners are attuned to the process of carrying their garbage cans to the curb for weekly pickup. In workplaces and commercial centers, waste management teams must collect trash, recyclables, and the like from stationed waste collection points for aggregation and removal. In warehouses, manufacturing plants, and other industrial processing sites, receptacles may collect and hold waste or recyclables with a more dangerous risk profile than typical homes and offices (e.g., flammable liquids and/or heavier solids). Receptacles across these different environments may also act as an inventory or storage container, whether in a home setting or in a work setting.

Container weight affects the handling of a receptacle. Receptacles, by themselves, can be heavy due to their designed purpose for safely and durably containing contents placed therein. Even when receptacles are made with an intent to reduce their independent weight (e.g., using a lighter thermoplastic instead of a heavier metal), the shape of a receptacle can limit the maximum suggested weight for a person to try to lift the receptacle. Once a receptacle has collected waste or other objects, the overall weight (or carrying weight) of a receptacle increases. In some instances, a receptacle will continue to collect waste or other objects until the receptacle has a full inner volume.

Lifting, moving, and emptying receptacles requires physical exertion that can result in personal injury. Tears, sprains, and strains of muscles and tendons are some of the most common types of occupational injuries. Waste managers, for instance, who are tasked with lifting, moving, and emptying receptacles on a regular basis, experience a high number of this type of injury due to their lifting, moving, and emptying receptacles. The heavier the receptacle, the more likely an injury.

Work regulations may impose lifting restrictions regarding how heavy a receptacle can be before a worker needs assistance (either through another person or using another tool or machinery). Other laws and regulations may impose restrictions on how much a person may fill a receptacle. Despite these laws and regulations, injuries still occur. Part of why injuries still occur is that receptacles lack an indicator of how heavy a receptacle actually is. This leaves the people filling a receptacle and the people lifting, moving, and emptying the receptacle with just their experience and surface observations to determine whether a receptacle is too full or too heavy.

### SUMMARY OF THE INVENTION

A receptacle scale is disclosed. The receptacle scale comprises a fitted base, an integrated scale, and a connected indicator. The fitted base receives a bottom to a receptacle. The bottom of the fitted base may also set onto a dolly, in addition to the top of the fitted base receiving a bottom to a receptacle. The receptacle scale is a standalone apparatus that may be an accessory to already existing receptacle designs and dolly designs.

It is to be understood that both the foregoing general description and the following detailed description are exemplary and explanatory only and are not necessarily restrictive of the disclosure as claimed. The accompanying drawings, which are incorporated in and constitute a part of the specification, illustrate embodiments of the disclosure and together with the general description, serve to explain the principles of the disclosure.

### BRIEF DESCRIPTION OF THE FIGURES

The numerous advantages of the present disclosure may be better understood by those skilled in the art by reference to the accompanying figures in which:

FIG. 1 is a perspective top and side view of an embodiment of the receptacle scale.

FIG. 2 is a perspective view of an embodiment of the receptacle scale engaged with a receptacle and a dolly.

FIG. 3 is a perspective view of a receptacle aligned to set on top of an embodiment of the receptacle scale and the embodied receptacle scale aligned to set on top of a dolly.

FIG. 4 is a perspective bottom and side view of an embodiment of the receptacle scale.

FIG. 5A is a perspective top and side view of an embodiment of the receptacle scale with a connected indicator embodied by a series of light sources.

FIG. 5B is a perspective top and side view of an embodiment of the receptacle scale with a connected indicator embodied by a digital display.

FIG. 5C is a perspective top and side view of an embodiment of the receptacle scale with a connected indicator embodied by an analog display.

FIG. 6 is a cross-sectional view of an embodiment of the receptacle scale engaged with a receptacle and a dolly.

FIG. 7 is a diagram of component parts in an embodiment of an integrated scale disposed within the receptacle scale.

FIG. 8 is a diagram of component parts in an embodiment of a system that includes an integrated scale disposed within the receptacle scale.

FIG. 9 is a flow chart diagram illustrating a method for providing an indication of the weight for a receptacle in accordance with an embodiment of the present disclosure.

### DETAILED DESCRIPTION

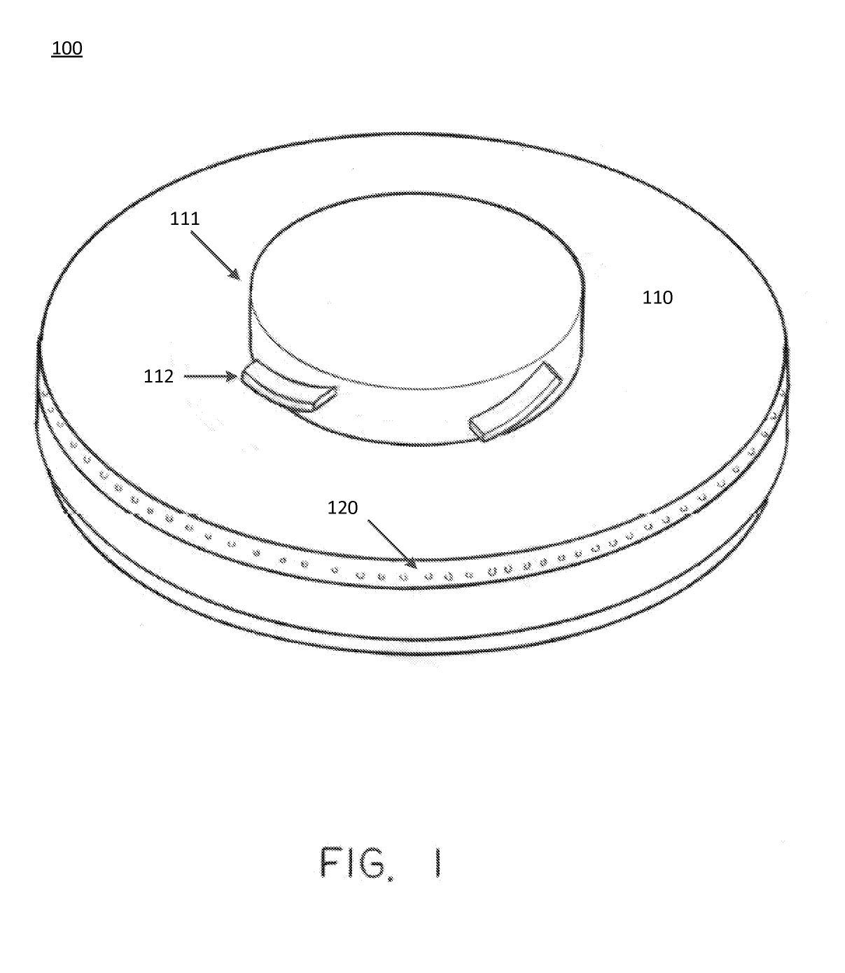

The present disclosure describes a receptacle scale for measuring the weight of a receptacle. Referring to FIG. 1, a receptacle scale 100 comprises a fitted base 110 and a connected indicator 120. The receptacle scale 100 embodied in FIG. 1 has a circular disk shape. In other embodiments the receptacle scale 100 may have other shapes. For example, in another embodiment the receptacle scale 100 may have a rectangular or square prism shape.

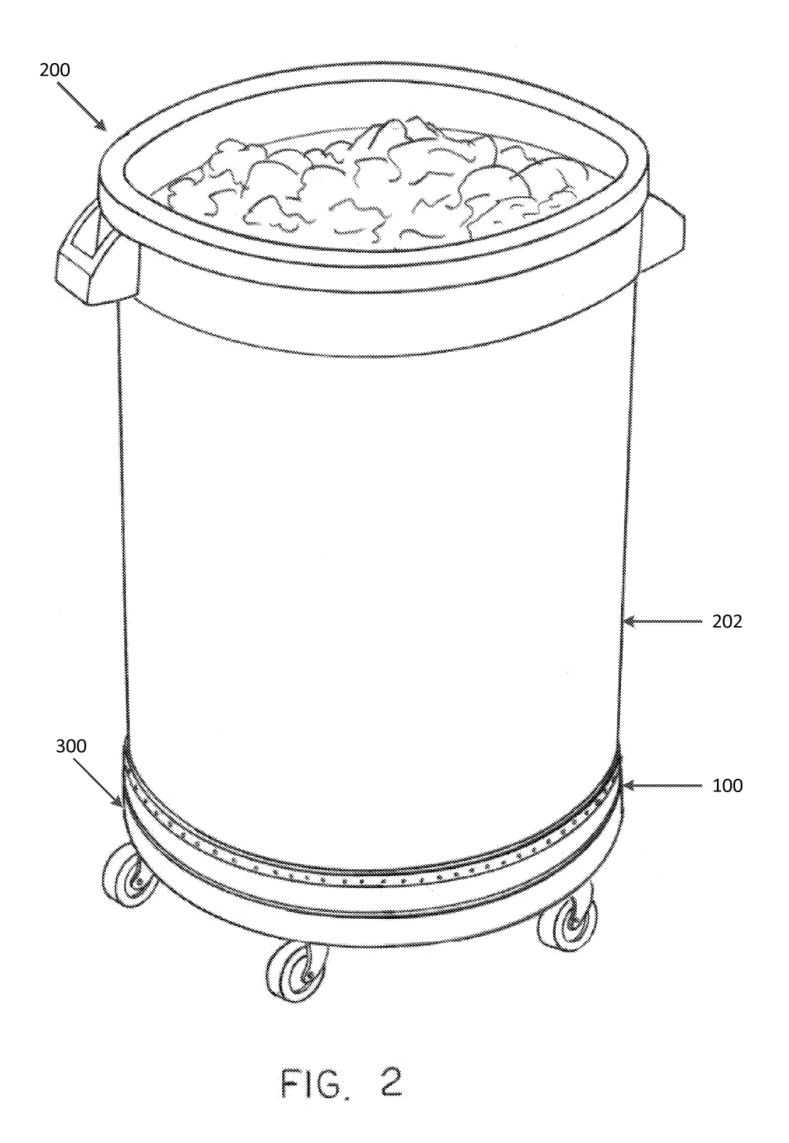

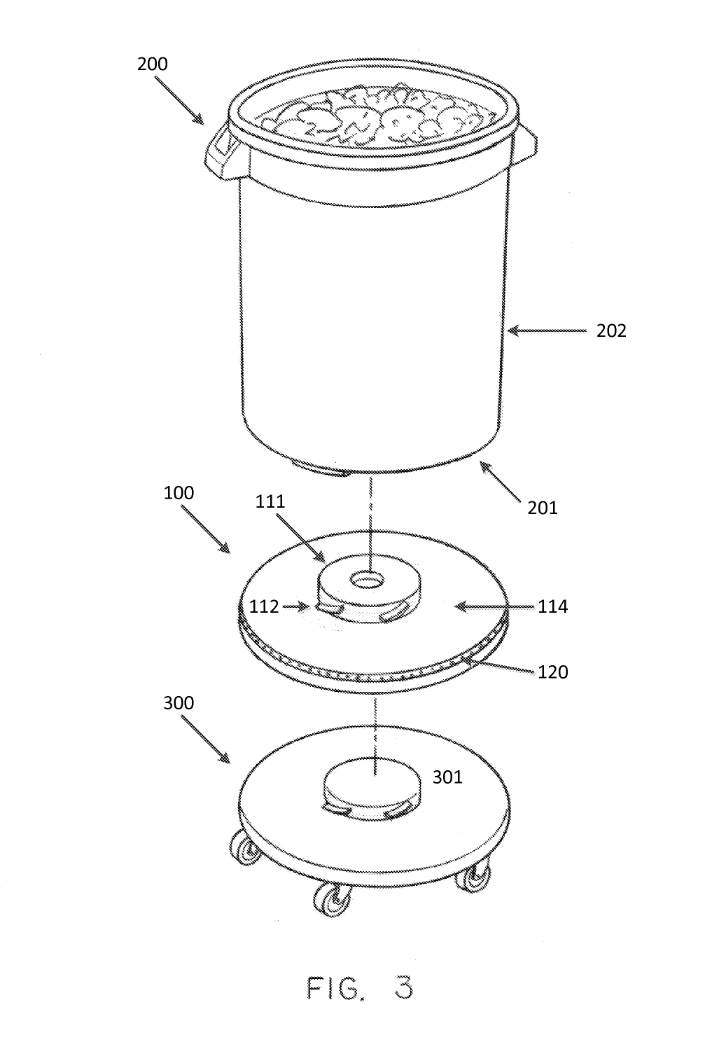

In embodiments of the present disclosure, such as the embodiment of FIG. 1, the fitted base 110 may have a raised platform 111. Seen in FIG. 2 and FIG. 3, the raised platform 111 may engage a bottom 201 to a receptacle 200. Engaging the bottom 201 to a receptacle 200 may comprise the raised platform 111 contacting (or pressing into) a raised (or impressed) recess forming the bottom 201 of the receptacle 200. Such a raised recess can improve the independent standing balance for the receptacle 200. For the present disclosure, the raised recess may enable the receptacle 200 to securely rest atop the receptacle scale 100 due, at least in part, to the contact created by the raised platform 111. The raised platform 111 may be sized to fit a particular size for the bottom 201. For example, the receptacle 200 may be a circular fifty five gallon receptacle, which is common in commercial and industrial settings. The raised platform 111 may also comprise a flexible but firm material (e.g., rubber) to create frictional resistance between the raised platform 111 and bottom 201, thereby improving engagement between the raised platform 111 fitted for the bottom 201 of a receptacle 200.

Exemplary embodiments of the raised platform 111 may include means for improving the engagement between the receptacle scale 100 and the bottom 201 of the receptacle 200 in order to better secure the receptacle 200 to the receptacle scale 100. For instance, as seen in FIGS. 1 and 3, the fitted base 110 may have a raised platform 111 with tabs 112 that may engage a recessed portion of the bottom 201. When setting the receptacle 200 atop the receptacle scale 100, turning or twisting the receptacle 200 (e.g., in a clockwise direction) aligns the tabs 112 with slightly raised ridges protruding toward the vertical center of the receptacle 200 from a side wall to the recessed portion of the bottom 201. Turning the receptacle 200 creates an interlocked engagement between the raised platform 111 on the receptacle scale 100 and the recessed portion of the receptacle 200. In another similar example, the raised platform 111 may be externally threaded to engage with internal threads in the bottom 201 of the receptacle 200.

More generally, in embodiments of the receptacle scale 100, the fitted base 110 may have a top surface configured to receive or engage one or more recesses, grooves, or other moldings on the bottom 201 of the receptacle 200. Receptacles often have bottoms designed for stacking during transport, improving standing balance when the receptacle is being used, and/or engaging with dollies or other support structures when the receptacle is being used. The top surface of the fitted base 110 may be configured (e.g., through thermoplastic molding) to fit into or receive the recesses, grooves, and/or other moldings on the bottom 201 of the receptacle 200.

In embodiments of the present disclosure, the fitted base 110 may have a containment wall. The containment wall may contact one or more enclosing side walls 202 to the receptacle 200. The containment wall may extend a distance from the top surface of the fitted base 110 such that the containment wall may help prevent the receptacle 200 from tipping over from atop the receptacle scale 100. The containment wall may be a rigid material (e.g., thermoset plastic) to create lateral inward resistance from the containment wall against the one or more enclosing side walls 202, thereby improving engagement between the containment wall and the receptacle 200. Similar to sizing for the raised platform 111, the containment wall may be a diameter to fit a particular size for the receptacle 200. For example, the containment wall may have an inner diameter substantially similar to an outer diameter of a receptacle 200 that is a circular fifty five gallon receptacle.

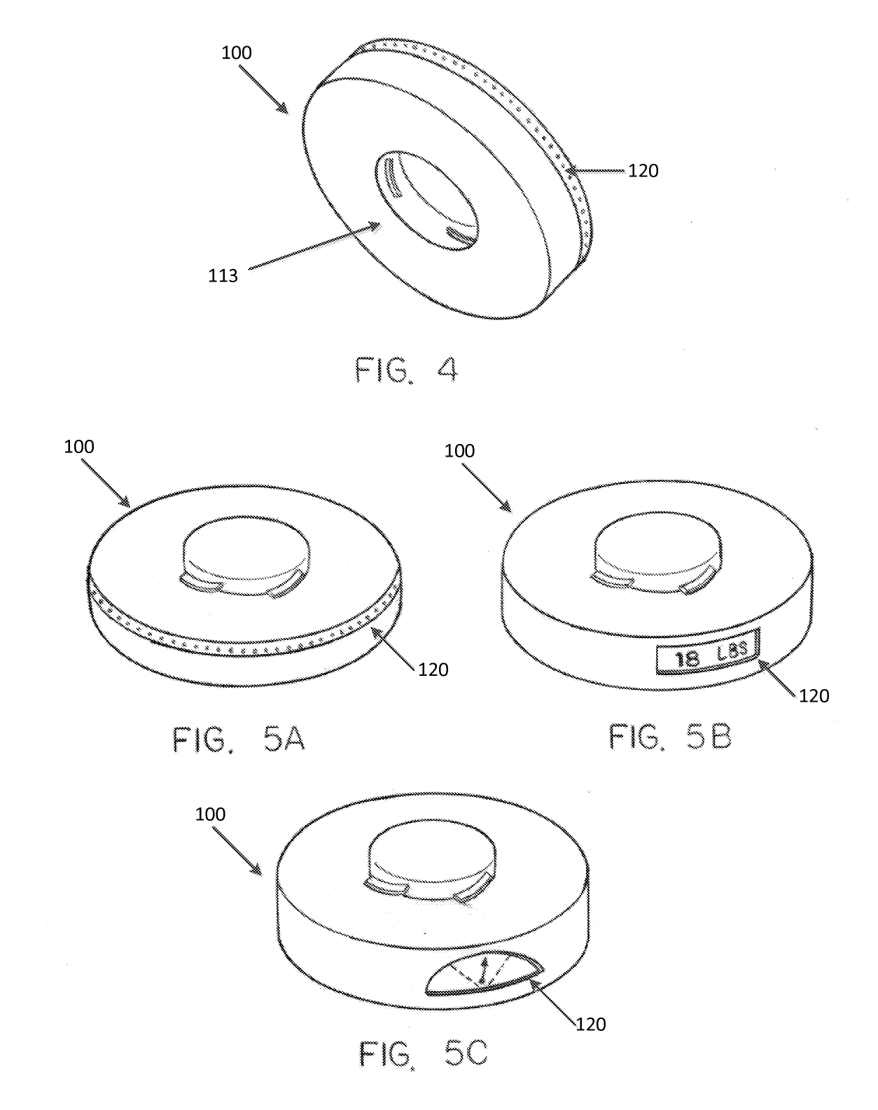

In embodiments of the present disclosure, the fitted base 110 of the receptacle scale 100 may also be shaped and/or configured to sit atop of a dolly 300. The dolly may have a plurality of casters with a dolly base 301 for receiving another apparatus, such as the receptacle scale 100. Seen in FIG. 4, the receptacle scale 100 has a fitted base 110 with a bottom layer 113 configured to sit within, on top of, and/or secured to the dolly base 301. Accordingly, the fitted base 110 also has a top layer 114 for receiving the receptacle 200, where receiving occurs as described above.

In other embodiments of the present disclosure, the fitted base 110 of the receptacle scale 100 may also be shaped and/or configured to sit inside and at a bottom of a receptacle 200. In such embodiments, the fitted base 110 of the receptacle scale 100 would receive a liner container that collects and holds the trash, recyclables, inventory, or other objects. The liner container (e.g., a thermoplastic bin or even a plastic bag) would be configured to fit within the receptacle 200. Thus, the receptacle scale 100 would have a top layer 114 configured (or enabled) to receive the liner container, and the receptacle scale 100 would also have a bottom layer 113 configured to sit within, on top of, and/or secured to the floor inside of the receptacle 200.

In another embodiment of the present disclosure, the fitted base 110 includes at least one foot pedal for disengaging the receptacle scale 100 from the bottom 201 to the receptacle 200. A foot pedal may be a rigid lip extending laterally outward from a side of the fitted base 110. A foot pedal or a combination of foot pedals would enable a user of the receptacle scale 100 to use his or her own body weight as leverage when disengaging a receptacle 200 set onto the receptacle scale 100. The leverage created by the user would create at least a downward force at the same time the user could lift the receptacle 200 with an upward force, thereby working to separate the receptacle scale 100 from the receptacle 200 when the connection is tight or more secure.

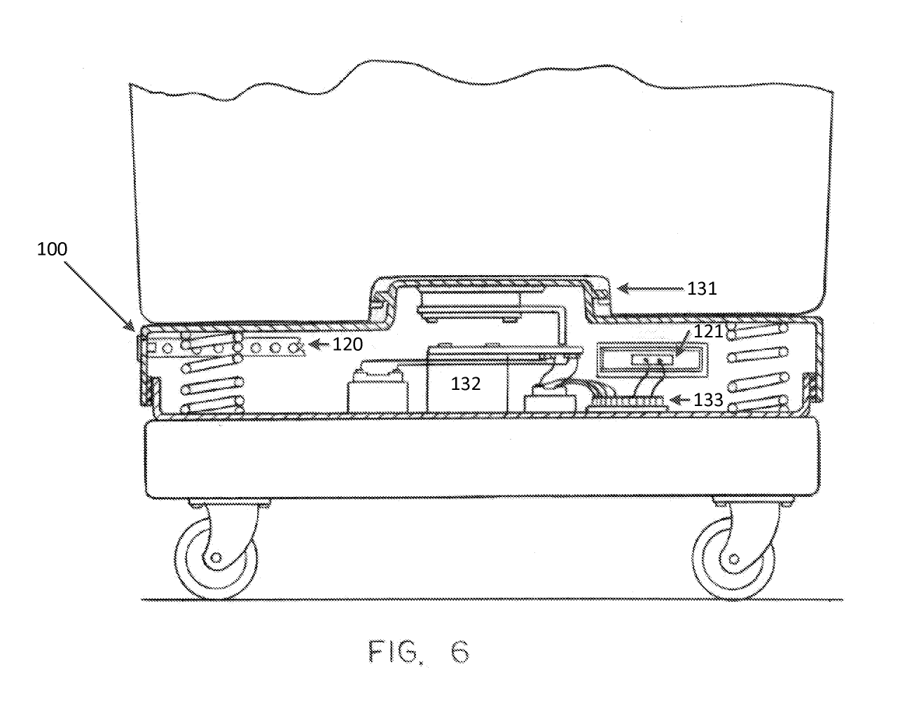

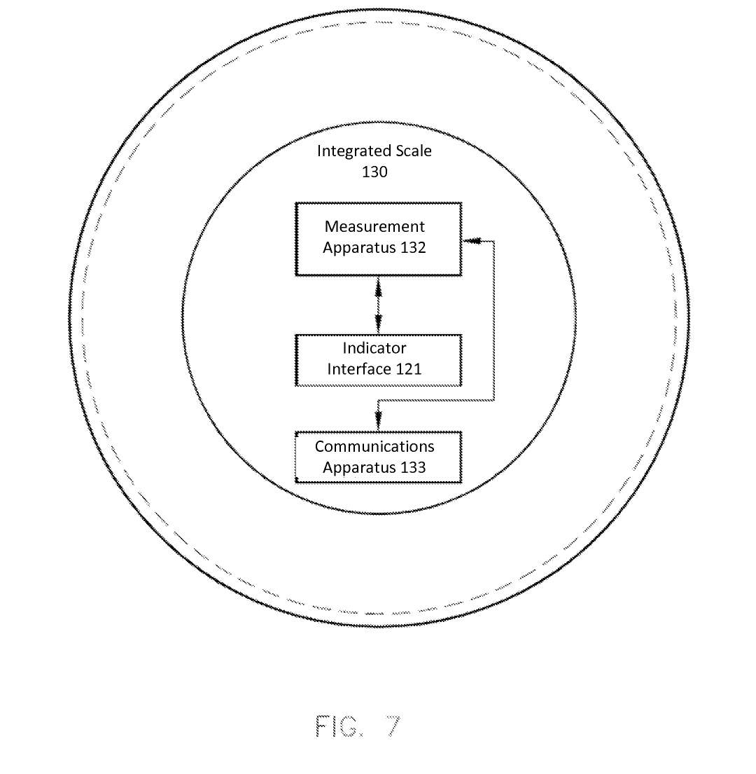

Next, the receptacle scale 100 also comprises an integrated scale 130 is set within the fitted base 110. Referring to FIG. 6, the integrated scale 130 fits within an internal cavity of the fitted base 110. The integrated scale 130 is secured to an internal surface of the fitted base 110. The fitted base 110 provides covering and protection of the integrated scale 130. The integrated scale 130 has a scale plate 131 that interfaces with the top layer 114 of the fitted base 110. In some embodiments the top layer 114 includes the raised platform 111 of the fitted base 110. The scale plate 131 receives a depression of the top layer 114 transferred from the force of the fitted base 110 receiving and supporting the receptacle 200.

The integrated scale 130 also includes a measurement apparatus 132. The scale plate 131 connects to the measurement apparatus 132 within the integrated scale 130. The measurement apparatus 132 measures force (or weight) from the receptacle 200 set atop of the receptacle scale 100. The measurement apparatus 132 may be a balance device type or scale device type, such as a strain gauge scale or spring scale. The measurement apparatus 132 may have one or more load cells displaced upon the scale plate 131 and used in measuring force (i.e., weight) applied to the scale plate 131 through the top layer 114 of the fitted base 110. In such an exemplary embodiment, the one or more load cells would be a component of the balance device or scale device comprising the measurement apparatus 132. The measurement apparatus 132 may also include circuitry for receiving and processing measurements collected at the scale plate 131.

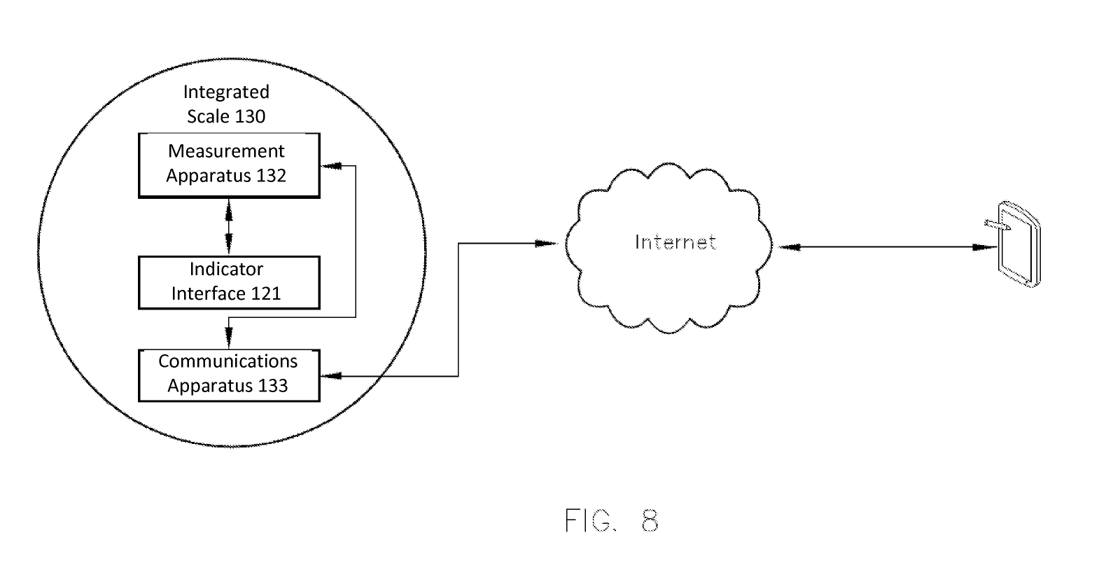

The measurement apparatus 132 causes the connected indicator 120 to produce a warning when the force exceeds a threshold. Referring to FIGS. 6 and 7, the measurement apparatus 132 may connect to the connected indicator through, for example, an indicator interface 121. The indicator interface 121 would provide a wired connection between the measurement apparatus 132 and connected indicator 120.

A threshold of the integrated scale 130 may be a weight measurement that corresponds, for example, to when it would no longer be safe for a single individual to lift, move, or displace the receptacle 200 or its contents for disposal or other disposition. A threshold may correspond to a weight measurement identified in regulatory restrictions, workplace rules, or other prescribed limits for lifting, moving, or displacing receptacles, containers, and other items for work purposes.

In some embodiments of the present disclosure, the measurement apparatus 132 stores a single threshold. In other embodiments of the present disclosure, there may a plurality of thresholds stored within the measurement apparatus 132. In some embodiments of the present disclosure, the one or more thresholds stored in a measurement apparatus 132 are predetermined and set during manufacturing (or production) of the receptacle scale 100. For other embodiments of the present disclosure, the one or more thresholds stored in a measurement apparatus 132 may be modified through an input interface disposed upon a surface of the receptacle scale 100 and connected to the measurement apparatus 132. For still other embodiments of the present disclosure, the one or more thresholds stored in a measurement apparatus 132 may be modified through signals and/or data transmitted to the measurement apparatus 132 through a communications apparatus 133, which is described below.

The measurement apparatus 132 operates electronically and relies upon a power source, such as an onboard battery or through wiring to an electrical outlet. The measurement apparatus 132 may also include means for resetting the balance device or scale device. Means for resetting the measurement apparatus 132 may help to ensure measurement accuracy. In an embodiment with such means, the measurement apparatus 132 may have a tare reset button disposed upon a surface of the fitted base 110 and connected to the circuitry of the measurement apparatus 132. When the tare reset button is pressed, the measurement apparatus 132 may reset its current state of measured force (i.e., weight) to zero.

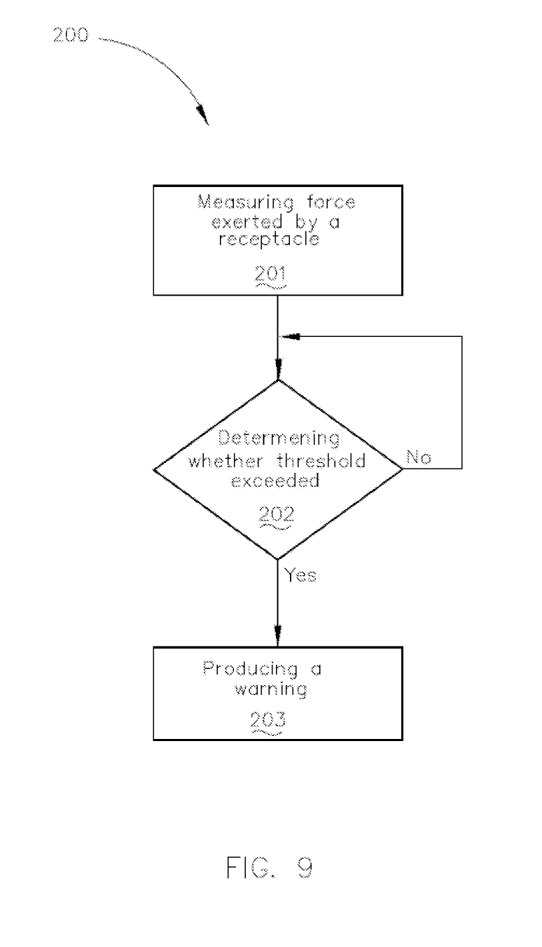

As seen in FIG. 6, FIG. 7, and FIG. 8, the integrated scale 130 may also include a communications apparatus 133. In such an embodiment, the communications apparatus 133 connects to the measurement apparatus 132 within the integrated scale 130. The communications apparatus 133 may comprise a wireless adapter for receiving and/or transmitting signals and/or data. Referring to FIG. 8, the communications apparatus 133 may connect to a network (e.g., the Internet) in order to receive and/or transmit signals and/or data. The communications apparatus 133 may also comprise processing components for receiving and processing signals and/or data from one or more remote operating devices, as well as for preparing signals and/or data for transmission to such devices. A remote operating device may be embodied by a smartphone, tablet, laptop, desktop, or other computing device connected to the communications apparatus 133 through a wired or wireless network.

In an embodiment of the present disclosure, the communications apparatus 133 may communicate with the measurement apparatus 132 to receive force (or weight) measurements about the receptacle 200. The communications apparatus 133 may then transmit such measurements to a remote operating device in order for the end user of the remote operating device to track how much trash or recyclables, for example, have been collected by the receptacle 200 (e.g., through software executing on the remote operating device). Additionally, or alternatively, the communications apparatus 133 may communicate with the measurement apparatus 132 to receive threshold statuses about the receptacle 200. The communications apparatus 133 may then transmit such statuses to the remote operating device in order for the end user of the remote operating device to receive notification that the items collected thus far by the receptacle 200 (e.g., trash and/or recyclables) have reached a threshold weight for the receptacle 200 (e.g., through software executing on the remote operating device).

In another embodiment of the present disclosure, the communications apparatus 133 may receive and/or store location information for the receptacle scale 100. For example, the location information may comprise data about where in a store, warehouse, or other commercial or industrial property the receptacle scale 100 is located. Location information may comprise an approximate location for the location where the receptacle scale 100 is used (e.g., Zone 3 for a commercial shopping center). In another embodiment, location information may comprise GPS coordinates. The communications apparatus 133 may then include the location information in transmissions to any connected remote operating devices communicating with the communications apparatus 133. Location information may be updated, for example, after a receptacle scale 100 is moved to a new location (e.g., if the receptacle scale 100 is engaged with a dolly 300 in addition to the scale 200 being engaged with a receptacle 200, and the combination of objects is moved to said new location).

Incorporating location information in transmissions from the communications apparatus 133 may assist an end user of the receptacle scale 100 in a number of ways, such as work efficiency and/or regulatory compliance. For example, it may help waste management staff in scheduling and performing waste collection duties to cut down on the number of receptacles visited when one or more receptacles are not full. In another example, it may help with fire code compliance if, for instance, the receptacles collect or contain flammable liquids or solids. Flammable liquids or solids may be subject to regulations or rules for fire separation areas, such restrictions on the permissible distance between certain volumes of the liquids or solids collected or contained in a receptacle 200. Location information transmitted from the communications apparatus 133 can provide data and feedback for complying with applicable local fire codes for such inventory.

The measurement apparatus 132 and the communications apparatus 133 may each individually comprise a digital integrated circuit and may each include one or more general, commercial off-the-shelf computer processors. Alternatively, each apparatus may comprise a programmable logic device configured for operating within the integrated scale 130. In yet another alternative, each apparatus may comprise an application specific integrated circuit (ASIC) designed for the integrated scale 130. Each apparatus may also include one or more analog elements operating in concert with or in addition to the digital circuits; furthermore, a memory element for storing data, instructions, or both may be part of or associated with each apparatus.

As introduced above, the measurement apparatus 132 can cause the connected indicator 120 to produce a warning when the force (i.e., weight) from a receptacle 200 set on top of the receptacle scale 100 exceeds a threshold. The connected indicator 120 may connect to the measurement apparatus 132 via wiring through the fitted base 110. The connection between the connected indicator 120 and the measurement apparatus 132 may include a connection to the power source of the measurement apparatus 132. In other embodiments, the connected indicator 120 may have a separate power source (e.g., a battery).

Referring to FIG. 5A, the connected indicator 120 may comprise one or more light sources. Referring to FIG. 5B, the connected indicator 120 may comprise a digital display (e.g., an LCD display). Referring to FIG. 5C, the connected indicator may comprise an analog display, such as a scale with a marked warning zone and an analog indicator (e.g., an indicator needle) that moves within the analog display.

In some embodiments, the connected indicator 120 may be disposed on a portion of the surface to the fitted base 110. In some embodiments, such as in FIG. 5A, the connected indicator 120 is disposed on a surface of the fitted base 110 in order for a person to see whether the connected indicator 120 is producing the warning. For example, in an embodiment where the connected indicator 120 comprises a plurality of light sources, the plurality of light sources may be disposed along the outfacing side surface of the fitted base 110. The warning from the connected indicator 120 comprising a plurality of light sources may be the connected indicator 120 turning on one or more of the light sources.

The light sources may be embodied by a variety of different sources. In one embodiment, the light sources may comprise a plurality of LEDs. The term LED may also refer to OLED (i.e., organic light-emitting diode). More generally, LED may refer to solid state lighting. In another embodiment, the light sources may comprise a plurality of small incandescent lamps. In another embodiment, the light sources are electroluminescent wire(s) (also known as “EL wires”). These types are exemplary and are not meant to be exhaustive, as other light source types may be used.

In other embodiments of the receptacle scale 100, the connected indicator 120 may be disposed on a portion of the surface to the receptacle 200. In such an embodiment, the disposition of the connected indicator 120 on a surface of the receptacle 200 modifies the location where a person sees whether the connected indicator 120 is producing the warning (i.e., the user's attention moves from the receptacle scale 100 to a position disposed on the surface of the receptacle 200). The connected indicator 120 in this embodiment would be communicatively coupled to the measurement apparatus 132 preferably through a wireless connection (e.g., Bluetooth, Wifi, etc.). Further, the connected indicator 120 in such an embodiment would comprise a separate, detached display and receiver with processing components. The receiver with processing components would receive triggering signals from the measurement apparatus 132 and translate those triggering signals into the warning produced through the display. The triggering signals would inform the connected indicator 120 whether the warning (e.g., light produced by one or more light sources) should be generated. For example, the warning from such a connected indicator 120 with a plurality of light sources for the display may be the connected indicator 120 turning on one or more of the light sources.

In yet another embodiment of the present disclosure, the connected indicator 120 is disposed within the fitted base 110, such as in the cavity where the measurement apparatus 132 is also disposed and secured. For example, in an embodiment where the connected indicator 120 comprises a sound device to produce an audible notification, the connected indicator 120 may be disposed on a surface of the fitted base 110 in the cavity, situated next to or proximal to the measurement apparatus 132.

The warning produced by the connected indicator 120 may be variety of warning types. As suggested above, the warning produced by the connected indicator 120 may be done using light. For example, the connected indicator 120 may turn on one or more light sources to indicate when the threshold has been exceed by the receptacle 200 resting on the receptacle scale 100. In another example, the connected indicator 120 may flash one or more light sources to indicate when the threshold has been exceeded. As yet another example, the connected indicator 120 may change the color of one or more light sources to indicate when the threshold has been exceed. As still another example, the connected indicator 120 may produce an audible notification such as a beeping sound or alarm sound. The connected indicator 120 may produce one warning type (e.g., turning on a light source or a strip of light sources). In other embodiments, the connected indicator 120 may produce more than one warning type (e.g., turning on a light source and producing an audible notification).

Referring to FIG. 9, there is an flow chart depicting a method 200 of providing an indication of the weight for a receptacle in an exemplary embodiment of this present disclosure. The method 200 comprises measuring the force (i.e., weight) from a receptacle 200 that sits on top of a receptacle scale 100 (Step 201). The receptacle scale 100 would include a fitted base 110, a connected indicator 120, and an integrated scale 130. As described above, the integrated scale 130 is disposed within the fitted base 110, while the connected indicator 120 is communicatively coupled with the integrated scale 130. The method also comprises determining the force exerted from the force from the receptacle 200 has exceeded a threshold stored by the integrated scale 130 (Step 202). Furthermore, the method comprises producing a warning using the connected indicator 120 when the force measured by the receptacle scale 100 has been determined to exceed the threshold (Step 203).

The method may comprise additional steps, as well. For instance, the method may also comprise transmitting data about the threshold being exceeded to a remote operating device. The transmission of such data would be accomplished through a communications apparatus 133 that is incorporated into the integrated scale 130 of the receptacle scale 100. As another example, the method may also comprise transmitting location data about the placement of the receptacle scale 100 and its accompanying receptacle 200.

The method may also comprise a number of different ways of producing the warning. In one exemplary embodiment where the connected indicator 120 comprises one or more light sources, the warning is produced by a flashing of light from the one or more light sources. In another exemplary embodiment where the connected indicator 120 comprises one or more light sources, the warning is produced by changing the color of light emanating from the one or more light sources. In another exemplary embodiment where the connected indicator 120 comprises a digital display, the warning is produced by displaying a word warning, such as “MAX” or “OVRWGHT.” In yet another exemplary embodiment where the connected indicator 120 comprises an analog display, the warning is produced by an analog indicator moving into a marked warning zone shown on the analog display. In still another exemplary embodiment where the connected indicator comprises an audio device, the warning is produced as an audible notification.

It is understood that certain components described herein may be electrically coupled in a number of ways. Components may be electrically coupled by one or more physical wired connections. Components may be electrically coupled by one or more intangible wireless connections. Components may be electrically coupled by a combination of one or more physical wired connections and intangible wireless connections.

It is understood that the specific order or hierarchy of steps in the foregoing disclosed methods are exemplary approaches. Based upon design preferences, it is understood the specific order or hierarchy of steps in the method can be rearranged while remaining within the scope of the present disclosure. The accompanying method claims present elements of the various steps in a sample order, and are not meant to be limited to the specific order or hierarchy presented.

Although the subject matter has been described in language specific to structural features and/or methodological acts, it is to be understood that the subject matter defined in the appended claim is not necessarily limited to the specific features or acts described above. Rather, the specific features and acts described above are disclosed as example forms of implementing the claim.

It is believed that the present disclosure and many of its attendant advantages will be understood by the foregoing description. It is also believed that it will be apparent that various changes may be made in the form, construction and arrangement of the modules and components thereof without departing from the scope and spirit of the disclosure or without sacrificing all of its material advantages. The form herein before described being merely an explanatory embodiment thereof, it is the intention of the following claims to encompass and include such changes.

What is claimed:

1. A receptacle scale for measuring the weight of a receptacle, the receptacle scale comprising:
a fitted base for receiving a bottom to the receptacle;
an integrated scale disposed within the fitted base; and
a connected indicator communicatively coupled with the integrated scale,
where the integrated scale measures force exerted by the receptacle upon the fitted base and causes the connected indicator to produce a warning when the force exceeds a threshold.

2. The receptacle scale of claim 1, wherein the connector indicator comprises one or more light sources.

3. The receptacle scale of claim 1, wherein connector indicator comprises a digital display.

4. The receptacle scale of claim 1, wherein the connector indicator comprises an analog display.

5. The receptacle scale of claim 1, wherein the integrated scale includes a communications apparatus for transmitting measurements to a remote operating device.

6. The receptacle scale of claim 1, wherein the fitted base includes a raised platform for engaging the receptacle scale with the bottom to the receptacle.

7. The receptacle scale of claim 1, wherein the fitted base includes at least one foot pedal for disengaging the receptacle scale from the bottom to the receptacle.

8. A receptacle providing an indication of its weight, the receptacle comprising:
a rigid container body including a top, a bottom, and one or more enclosing side walls; and
a receptacle scale that includes a fitted base, an integrated scale disposed within the fitted base, and a connected indicator communicatively coupled with the integrated scale, where
the top of the rigid container body is open for receiving and collecting objects for containment by the rigid container body,
the fitted base receives the bottom of the rigid container body, and
the integrated scale measures force exerted by the rigid container body upon the fitted base and causes the connected indicator to produce a warning when the force exceeds a threshold.

9. The receptacle of claim 8, wherein the connector indicator comprises one or more light sources.

10. The receptacle of claim 8, wherein connector indicator comprises a digital display.

11. The receptacle of claim 8, wherein the connector indicator comprises an analog display.

12. The receptacle of claim 8, wherein the integrated scale includes a communications apparatus for transmitting measurements to a remote operating device.

13. The receptacle of claim 8, wherein the fitted base includes a raised platform for engaging the receptacle scale with the bottom of the rigid container body.

14. The receptacle of claim 8, wherein the fitted base includes at least one foot pedal for disengaging the receptacle scale from the bottom to the rigid container body.

15. A method of providing an indication of the weight for a receptacle, the method comprising:
measuring force exerted by a receptacle set upon a receptacle scale that includes a fitted base, an integrated scale disposed within the fitted base, and a connected indicator communicatively coupled with the integrated scale;
determining when the force exerted by the receptacle exceeds a threshold stored by the integrated scale; and
producing a warning through the connected indicator when the force exceeds the threshold.

16. The method of claim 15, further comprising transmitting data on the threshold being exceeded to a remote operating device through a communications apparatus included in the integrated scale.

17. The method of claim 15, wherein producing the warning is a flashing of one or more light sources comprising the connected indicator.

18. The method of claim 15, wherein producing the warning is a change in color of one or more light sources comprising the connected indicator.

19. The method of claim 15, wherein producing the warning is producing a word warning on a digital display comprising the connected indicator.

20. The method of claim 15, wherein producing the warning is moving an analog indicator to a marked warning zone of an analog display comprising the connected indicator.
